(19) United States
(12) Patent Application Publication
(10) Pub. No.: US 2025/0383304 A1
(43) Pub. Date: Dec. 18, 2025

(54) X-RAY MEASUREMENT ARRANGEMENT FOR EXAMINING TEST OBJECTS WITH X-RAY RADIATION AND METHOD FOR EXAMINING TEST OBJECTS WITH X-RAY RADIATION

(71) Applicant: Carl Zeiss Industrielle Messtechnik GmbH, Oberkochen (DE)

(72) Inventors: Martin Krenkel, Aalen (DE); Bastian Rothaupt, Aalen (DE); Wolfgang Kimmig, Aalen (DE); Christoph Kuhn, Langenau (DE); Dominik Stahl, Oberkochen (DE); Christian Wojek, Aalen (DE)

(21) Appl. No.: 19/178,922

(22) Filed: Apr. 15, 2025

Related U.S. Application Data
(63) Continuation of application No. PCT/EP2022/079408, filed on Oct. 21, 2022.

(51) Int. Cl. G01N 23/083; G01N 23/04

(52) U.S. Cl. CPC G01N 23/083; G01N 23/04; G01N 2223/309; G01N 2223/3306

(57) ABSTRACT

An X-ray measurement arrangement for examining test objects with X-ray radiation includes a rotatable receiving device, an X-ray examination device having at least one X-ray source, and at least one X-ray detector. The at least one X-ray source and the at least one X-ray detector are arranged on the rotatable receiving device. The arrangement further includes at least one positioning device configured to arrange at least one predetermined region of interest of a test object in a detection area of the X-ray examination device on an axis of rotation of the rotatable receiving device, between the at least one X-ray source and the at least one X-ray detector and to hold it there during the examination. In addition, a method for examining test objects with X-ray radiation is provided.

### CROSS REFERENCE TO RELATED APPLICATIONS

This application is a continuation application of international patent application PCT/EP2022/079408, filed Oct. 21, 2022, designating the United States, and the entire content of this application is incorporated herein by reference.

### TECHNICAL FIELD

The disclosure relates to an x-ray measurement arrangement for examining test objects with x-ray radiation, and to a method for examining test objects with x-ray radiation.

### BACKGROUND

Following production, it is common practice in the field of industrial metrology to subject test objects, in particular workpieces, to a quality check using non-invasive examination methods in order to identify deviations from desired properties. In particular, x-ray radiation can be used to this end, in order to acquire radiographs of the test object. If the test object is radiographed from different directions, an internal structure (object volume) of the test object can be calculated (reconstructed) within the scope of computed tomography.

The prior art describes industrial computed tomography (CT) scanners that are typically constructed in such a way that x-ray source and x-ray detector are stationary while the radiographs are acquired, while the test object to be measured is arranged on a rotary stage and rotated with said rotary stage (e.g. VoluMax series computed tomography scanners by Carl Zeiss AG, https://www.zeiss.de/messtechnik/produkte/systeme/computertomogra phie/volumax.html). Such computed tomography scanners may be integrated in a production line, wherein, e.g., a robot arm loads the test objects through a loading door and arranges them on the rotary stage. A disadvantage of this type of computed tomography scanner is that even if short CT scanning times in the order of 1-2 seconds are possible, a significant proportion (typically approx. 10 to 20 seconds) is required for loading, opening and closing the door and positioning a region of interest (ROI) of the test object in the beam path or on the rotary stage. The region of interest may contain a part of the test object or the entirety thereof.

Medical engineering has disclosed gantry systems (e.g., see EP 1 646 316 B1) or C-arm systems (e.g. see U.S. Pat. No. 7,170,972 B2). In these systems, x-ray source and x-ray detector rotate about a structurally defined axis of rotation, and the measurement object (the patient in the field of medicine) is placed in the proper position in the beam path on a defined axis of rotation, and the measurement object (the patient in the field of medicine) is placed in the proper position in the beam path on a stationary stage and remains motionless during the measurement. A substantial disadvantage of these systems is that access to the measurement region (acquisition region) is greatly restricted. For example, in the case of gantry systems, a maximum diameter of the objects to be measured is limited by the central opening in the middle.

WO 2007/055501 A1 describes an x-ray cone beam micro-CT scanner that is able to supply an image with a superior spatial resolution. The CT scanner includes the functions of both an object-rotated mode and a gantry-rotated mode. The “object-rotated” mode includes the object being rotated during the scan under the condition of a fixed x-ray source and a fixed detector. The gantry rotation mode includes both an x-ray source and a detector mounted on a gantry being rotated during the scan, in a manner dependent on the state of a fixed object. In the “object-rotated” mode, the CT scanner scans the object, which is situated in the vicinity of the focus of the x-ray tube, and then rotates it while a small object, e.g., a severed bone piece, is scanned. In the gantry rotation mode, the CT scanner scans a fixed object and rotates a gantry, if it scans a small living animal such as a mouse.

CN 111 157 556 B describes a low-energy CT detector, a CT detection system and a detection method. The CT detector includes high-energy detectors and low-energy detectors, wherein the high-energy detectors and the low-energy detectors are arranged in a back-to-back mode and one high-energy detector is arranged below each low-energy detector; the number of lines of high-energy detectors is larger than the number of lines of low-energy detectors, and at least some of the low-energy detectors are distributed centrally. Some of the low-energy detectors of the CT detector are arranged centrally, reducing costs and simultaneously providing a high image accuracy.

CN 108 072 673 A describes a rocky core CT device. The rocky core CT device includes a radiation source, a detector and a rocky core conveying mechanism, wherein the radiation source and the detector are mounted on a rotational disk and the rotational disk can be made to rotate by a rotational force; the rocky core conveying mechanism includes a drive part and a driven part, a rocky core bed is arranged on the drive part and the driven part, and two ends of the rocky core bed are respectively situated on the drive part and the driven part; the rocky core bed may be driven by a force apparatus in the drive part such that it is moved backward and forward; the rocky core bed passes through the center of the rotary disk; an assembly base is situated between the drive part and the driven part. The rocky core CT device has a high scanning speed and is convenient in operation.

CN 1 169 000 C describes a multi-angle tomography system. The latter includes a rotating gantry with a source, e.g., an x-ray source, and a detector array combination mounted thereon in order to capture a plurality of projections of objects that pass through the gantry. A pre-screen subsystem uses a subset of those projections that can be acquired during a complete scan in order to define a first plurality of projections—e.g., eight projections—that are sufficient to analyze whether there is the probability of a target object, e.g., a firearm and/or plastic explosive, being present. If there is the probability of a target object being present, a full image CT reconstruction is ordered automatically or manually in order to test the identified object and assess the latter more comprehensively. This combination of pre-examination and selective full image CT reconstruction enables a thorough inspection of closed containers, e.g., passenger luggage, by observing the target objects from a plurality of viewing angles and perspectives.

### SUMMARY

It is an object of the disclosure to improve an x-ray measurement arrangement for examining test objects with x-ray radiation and a method for examining test objects with x-ray radiation. In particular, a cycle time that is as short as possible should be rendered possible when examining the test objects.

The object is achieved by an x-ray measurement arrangement for examining test objects with x-ray radiation and a method for examining test objects with x-ray radiation as described herein.

One of the basic ideas of the disclosure is that of arranging an x-ray examination apparatus with at least one x-ray source and at least one x-ray detector on a rotatable receptacle apparatus. In principle, the rotatable receptacle apparatus may have any desired form; by preference, the rotatable receptacle apparatus has the form of a rotatable disk or a rotatable bar. In particular, the x-ray examination apparatus is arranged in such a way on the rotatable receptacle apparatus that the axis of rotation of the rotatable receptacle apparatus, and hence a center of rotation in particular, extends through the beam path. In the case of a receptacle apparatus that is configured as a rotatable disk, a mean propagation direction of the beam path between the at least one x-ray source and the at least one x-ray detector extends parallel to a plane of the rotatable disk. Expressed differently, an active detector surface of the at least one x-ray detector is perpendicular to the plane of the rotatable disk. A test object arranged on the axis of rotation, between the at least one x-ray source and the at least one x-ray detector, may therefore be radiographed with the x-ray examination apparatus. The x-ray examination apparatus is also rotated about the axis of rotation as a result of the rotation of the rotatable receptacle apparatus, and so it is possible to capture a test object arranged on the axis of rotation, in particular in the rotation of the rotatable receptacle apparatus, between the at least one x-ray source and the at least one x-ray detector, and to keep said region of interest there during the examination. The examined region of interest is kept at the center of rotation of the x-ray examination apparatus by the positioning apparatus, and so radiographs may be acquired from different directions. As a result, the region of interest may be examined by computed tomography.

In particular, an x-ray measurement arrangement for examining test objects with x-ray radiation is developed, including a rotatable receptacle apparatus, an x-ray examination apparatus having at least one x-ray source and at least one x-ray detector, the at least one x-ray source and the at least one x-ray detector being arranged on the rotatable receptacle apparatus, and at least one positioning apparatus that is configured to arrange at least one predetermined region of interest of a test object in an acquisition region of the x-ray examination apparatus at an axis of rotation of the rotatable receptacle apparatus, between the at least one x-ray source and the at least one x-ray detector, and to keep said region of interest there during the examination.

Further, a method for examining test objects with x-ray radiation is provided in particular, wherein an x-ray measurement arrangement according to an exemplary embodiment described in this disclosure is used, wherein the at least one positioning apparatus is used to arrange at least one predetermined region of interest of a test object in the acquisition region of the x-ray examination apparatus on the axis of rotation of the rotatable receptacle apparatus, between the at least one x-ray source and the at least one x-ray detector, and to keep said region of interest there during the acquisition of at least one radiograph with the at least one positioning apparatus.

An advantage of the x-ray measurement arrangement lies in the possibility of obtaining short cycle times, and so an in-line examination and/or test of workpieces in a manufacturing line can be improved. In particular, this is possible on account of an arrangement on a rotary stage no longer being required since the at least one positioning apparatus arranges a region of interest of the test object in the acquisition region and also holds said region of interest in position there while the radiographs are acquired. In that case, radiographs are acquired from different directions by rotating the rotatable receptacle apparatus (e.g., the rotatable disk or the rotatable bar), whereby the x-ray examination apparatus is rotated about the axis of rotation and hence about the region of interest arranged there.

Furthermore, the disclosed x-ray measurement arrangement advantageously also allows the examination of regions of interest of large test objects. For example, if opposite corners of large batteries or battery cells should be examined as respective regions of interest (ROI) (ROI 1 first, followed by ROI 2), then the battery must be displaced in such a way that ROI 1 first and subsequently ROI 2 are arranged at the center of rotation. To allow good radiographing of the corner of the battery, radiation must pass through the latter at an angle. This is possible without problems using the disclosed x-ray measurement arrangement even for battery dimensions of for example approx. 500 mm×150 mm×50 mm and a tilt angle of 45°, whereas a gantry system would require a very large central opening and hence a large distance between x-ray source and x-ray detector (>1000 mm). This would result in fewer photons arriving at the x-ray detector than in the case of an optimal shorter distance (e.g., approx. 400 mm), and so a gantry system would no longer allow short measurement times in that case, especially because the number of photons incident on the x-ray detector is proportional to the square of the distance between x-ray source and x-ray detector.

The rotatable receptacle apparatus is accessible from at least one side, the side on which the x-ray examination apparatus is arranged.

The rotatable receptacle apparatus may be configured as a rotatable disk. In particular, the rotatable disk is a circular disk, i.e., an outer contour is circular. However, the rotatable disk in principle need not have a circular shape; in particular, an outer contour of the rotatable disk may also have any other suitable shape. In particular, the rotatable disk may also be referred to as a (flat) plate.

The x-ray measurement arrangement is an x-ray measurement arrangement from industrial metrology. A typical application of the x-ray measurement arrangement is a quality control of test objects at the end of a production line. In particular, the examined test objects are similar, with the same testing task always being performed for a plurality of test objects. However, different test objects may in principle also be examined using the x-ray measurement arrangement. The test objects are workpieces.

In particular, the x-ray measurement arrangement is configured to allow a computed tomography measurement. The x-ray measurement arrangement forms a computed tomography scanner to this end. To this end, the x-ray measurement arrangement, more particularly the x-ray examination apparatus, may also include a control device, the latter being provided to perform the computed tomography evaluation. The control device is configured to reconstruct and provide an object volume from radiographs that were acquired from different directions.

In particular, the test objects are arranged with the at least one positioning device from a direction that substantially coincides with the axis of rotation. In particular, provision is made for the at least one positioning device to be arranged relative to the rotatable receptacle apparatus such that the test objects may be arranged and removed from/in a direction perpendicular to an accessible side face of the rotatable receptacle apparatus, perpendicular to the (accessible) plane or perpendicular to a mean propagation direction of a beam path of the x-ray examination apparatus in the event of a rotatable disk.

For example, the test objects might be batteries or battery cells. The test objects, in particular the batteries or battery cells, are elongate test objects, for example with a side ratio in the order of 50:15:5. For example, a battery or a battery cell may have dimensions in the order of 500 mm×150 mm×50 mm.

In particular, at least one drive is provided for rotating the rotatable receptacle apparatus. For example, provision can be made for the rotatable receptacle apparatus to be a circular disk, arranged at the external circumference of which is an externally or laterally toothed gear ring into which a pinion connected to the drive engages. For example, the drive may be an electric motor.

Electrical connections for supplying power and/or signal lines may have a suitable configuration for the specific embodiment. For example, sliding contacts might be provided such that the rotatable receptacle apparatus can be rotated without restrictions. By contrast, if a restriction of the angular range about which the rotatable receptacle apparatus may be rotated is provided (e.g., in the order of at least) 180°, then the electrical connections and/or signal lines may also be configured as wired connections.

An exemplary embodiment provides for the at least one x-ray source and/or the at least one x-ray detector to be movable along a linear axis that extends perpendicular to the axis of rotation of the rotatable receptacle apparatus. In particular, the linear axis extends in the radial direction. This allows a distance between the at least one x-ray source and the at least one x-ray detector to be changed. This allows increased flexibility when defining a magnification, something that is not possible with gantry systems and C-arm systems. A magnification and/or a resolution of the region of interest of the test object may be set flexibly and according to requirements as a result of the movable at least one x-ray source and the movable at least one x-ray detector. In particular, provision is made for at least one drive, with which the at least one x-ray source and the at least one x-ray detector can be moved along the linear axis. For example, such a drive may be a linear motor or a spindle drive. Should the rotatable receptacle apparatus be configured as a rotatable disk, provision is in particular made for the at least one x-ray source and the at least one x-ray detector to be movable along a linear axis that extends radially with respect to the rotatable disk.

An exemplary embodiment provides for the rotatable receptacle apparatus to be arranged such that the axis of rotation of the rotatable receptacle apparatus extends horizontally. This allows horizontal supply and removal of test objects to and from the acquisition region of the x-ray examination apparatus, which is particularly advantageous for integrating the test object examination into a production line. In this case, a horizontal extent of the axis of rotation may also contain a tolerance range.

An exemplary embodiment provides for the rotatable receptacle apparatus to be configured such that the latter has no restrictions whatsoever on an angle of rotation about the axis of rotation. This allows a full rotation, during which an angular range of at least 360° may be covered when acquiring radiographs. If it is possible to continue rotating the rotatable receptacle apparatus continually, then this allows drives and gearing (teeth, gear wheels, etc.) to be spared since it is possible to manage without accelerations and decelerations when interchanging the test objects. In that case, the rotatable receptacle apparatus is rotated without stopping while all measurements are performed. Then, electrical connections and/or signal lines are formed with sliding contacts.

An exemplary embodiment provides for the x-ray measurement arrangement to include at least two positioning apparatuses that operate independently of one another and, in each case at least one x-ray detector to be movable along a linear axis that extends radially with respect to the rotatable disk.

An exemplary embodiment provides for the rotatable receptacle apparatus to be arranged such that the axis of rotation of the rotatable receptacle apparatus extends horizontally. This allows horizontal supply and removal of test objects to and from the acquisition region of the x-ray examination apparatus, which is particularly advantageous for integrating the test object examination into a production line. In this case, a horizontal extent of the axis of rotation may also contain a tolerance range.

An exemplary embodiment provides for the rotatable receptacle apparatus to be configured such that the latter has no restrictions whatsoever on an angle of rotation about the axis of rotation. This allows a full rotation, during which an angular range of at least 360° may be covered when acquiring radiographs. If it is possible to continue rotating the rotatable receptacle apparatus continually, then this allows drives and gearing (teeth, gear wheels, etc.) to be spared since it is possible to manage without accelerations and decelerations when interchanging the test objects. In that case, the rotatable receptacle apparatus is rotated without stopping while all measurements are performed. Then, electrical connections and/or signal lines are formed with sliding contacts.

Provision is made for the x-ray measurement arrangement to include at least two positioning apparatuses that operate independently of one another and, in each case assigned to each of the at least two positioning apparatuses, supply and removal devices for supplying and removing test objects to be examined. This may reduce a period of time during which the x-ray examination apparatus is unused since an arrangement of the test objects may be implemented in alternation by the at least two positioning apparatuses. While one of the position apparatuses removes an already examined test object from the acquisition region and transfers said test object to the removal device, another one of the position apparatuses may already arrange a further test object in the acquisition region and hold said test object there. Removal and supply devices may also be assigned jointly to the at least two positioning apparatuses.

An exemplary embodiment provides for the x-ray measurement arrangement to include at least one third linear axis which extends parallel to the axis of rotation and along which the at least one x-ray source and/or the at least one x-ray detector can be displaced. This allows a displacement of the beam path along the axis of rotation. For example, this allows an examination of test objects of different sizes when a positioning carousel is used. A course of the beam path may then be set flexibly by the at least one third linear axis that extends parallel to the axis of rotation, by virtue of displacing the beam path parallel to said axis of rotation. Further, this also allows incremental measurement of a larger volume. In particular, provision is made for at least one drive, with which the at least one x-ray source and the at least one x-ray detector can be moved along the third linear axis that extends parallel to the axis of rotation. For example, such a drive may be a linear motor or a spindle drive. Movement of the at least one x-ray source and/or of the at least one x-ray detector may in principle be implemented jointly, i.e., in a mechanically coupled fashion, or else separately, i.e., separate from one another.

An exemplary embodiment provides for a drive for moving the at least one x-ray source and the at least one x-ray detector along the linear axis that extends perpendicular to the axis of rotation of the rotatable receptacle apparatus to be arranged outside of the rotatable receptacle apparatus. As a result, the drive need not be moved with the rotatable receptacle apparatus when the latter is rotated, reducing complexity and allowing costs to be saved. Since, as a rule, the same testing task is performed on similar test objects at all times, retrofitting or movement will only be seldom required. However, should this be the case, the drive arranged outside of the rotatable receptacle apparatus is used to this end. For example, suitable (coupling) elements are provided to this end, with which the drive may be coupled to the linear axis and decoupled therefrom.

An exemplary embodiment provides for the x-ray measurement arrangement to include at least one wireless communications interface that is arranged on the rotatable receptacle apparatus and configured to provide radiographs acquired with the at least one x-ray detector and/or an evaluation result (e.g., an object volume reconstructed from acquired radiographs). This allows fast data transfer to the x-ray detector, wherein it is possible to manage without sliding contacts for signal lines in particular. For example, the communications interface may meet the Wi-Fi 6 standard (IEEE 802.11ax), and so data rates of up to 5 Gbit/s are rendered possible. Provision is also made for at least parts of a control device of the x-ray measurement arrangement and/or of the x-ray examination apparatus to be arranged on the rotatable receptacle apparatus and to communicate with the wireless communications interface, for example with an external operating unit or a remote control.

An exemplary embodiment provides for the at least one x-ray source to be a microfocus x-ray source. A high resolution may be obtained during the radiograph acquisition as a result. In this case, a microfocus x-ray source is an x-ray source in which an effective region where x-ray radiation is generated has a diameter of between 2 and 100 μm.

An exemplary embodiment provides for the at least one x-ray source to include a monoblock x-ray tube. This has the advantage that high-voltage cables with a large diameter need not be carried along during the rotation of the rotatable receptacle apparatus. By contrast, a voltage supply via a sliding ring and sliding contacts is sufficient. A high-voltage generator is already integrated into the x-ray tube in the case of a monoblock x-ray tube.

An exemplary embodiment provides for the at least one x-ray detector to be embodied as a direct conversion x-ray detector. As a result, it is possible to manage without a scintillation layer. This allows a readout speed of the at least one x-ray detector to be increased, and so a measurement time overall can be reduced. As a consequence, this allows a reduction in the cycle time with which test objects may be examined. For example, a direct conversion x-ray detector may be a photon-counting x-ray detector that works with CdTe as active material. Such an x-ray detector may be read out at a readout rate of >1000 frames per second, and so there can be a reduction in motion unsharpness in the event of measurements using a continual rotation of the rotatable receptacle apparatus and of the x-ray examination apparatus.

An exemplary embodiment provides for the at least one x-ray source and/or the at least one x-ray detector to have fluid cooling. This may improve a performance of the at least one x-ray source and/or of the at least one x-ray detector since it is possible to generate x-ray radiation with a greater brilliance and/or reduce detector noise. For example, the fluid cooling may use water or oil as media. In particular, a cooling circuit in this case is arranged in full on the rotatable disk. For example, in the event of water cooling, the cooling medium can be used to distribute local heat inputs over a larger area. The cooling medium can then be efficiently cooled elsewhere should passive cooling by simple pumping through the cooling circuit not be sufficient.

An exemplary embodiment provides for the x-ray measurement arrangement to include at least one door-free radiation lock. This dispenses with a time which is required for the opening and closing of a door of the radiation lock and during which radiographs cannot be acquired. This also dispenses with wear-and-tear due to continual and fast opening and closing of the door. In particular, the door-free radiation lock is configured to prevent primary x-ray radiation from passing through the door-free radiation lock and ensure that scattered radiation is attenuated sufficiently so that no radiation is detectable outside of the radiation lock. In particular, the door-free radiation lock works with screens (displaced with respect to one another) that form a type of channel through which the x-ray radiation cannot pass but supply and removal of the test objects is possible. The supply and removal of test objects can thus be decoupled from an x-ray examination apparatus operation. This may reduce a cycle time.

An exemplary embodiment provides for the x-ray examination apparatus to include a plurality of x-ray sources and a plurality of x-ray detectors. This may reduce a time required for a measurement. In particular, this may reduce a cycle time. In particular, the respective beam paths are arranged offset about the axis of rotation such that a plurality of radiation transmission directions can be acquired simultaneously.

An exemplary embodiment provides for the x-ray measurement arrangement to include at least one collimator and/or at least one stop element and/or at least one filter element which is/are configured to limit an x-ray radiation emanating from the at least one x-ray source to an active detector surface of the at least one x-ray detector.

An exemplary embodiment of the method provides for a predetermined last segment of an arrangement trajectory to extend along the axis of rotation of the rotatable receptacle apparatus when arranging the at least one predetermined region of interest of the test object in the acquisition region. This can prevent a collision with the at least one x-ray source and/or the at least one x-ray detector, especially if the rotatable receptacle apparatus rotates during the arrangement, for example in the event of a continual rotation of the rotatable receptacle apparatus.

A further exemplary embodiment of the method provides for at least two positioning apparatuses that operate independently of one another to be used with supply and removal devices, in each case assigned to each of the at least two positioning apparatuses, for supplying and removing test objects to be examined, in order to arrange the at least one predetermined region of interest of the test objects in the acquisition region, with the at least two positioning apparatuses being used alternately in the process. This can increase a measurement time in relation to a clock time. In particular, this can reduce a time during which no test object can be measured. Overall, this can further reduce a cycle time of the examination per test object. In particular, the at least two positioning devices are robot arms.

### BRIEF DESCRIPTION OF THE DRAWINGS

The disclosure will now be described with reference to the drawings wherein:

FIG. 1 shows a schematic illustration of the x-ray measurement arrangement for examining test objects with x-ray radiation according to an exemplary embodiment of the disclosure;

FIG. 2 shows a schematic illustration for elucidating a rotational movement of the rotatable receptacle apparatus and a movement along the linear axis that extends perpendicular to the axis of rotation or radially;

FIG. 3 shows a schematic illustration of the x-ray measurement arrangement for examining test objects with x-ray radiation according to a further exemplary embodiment of the disclosure;

FIG. 4 shows a schematic illustration for elucidating further linear axes; and

FIG. 5 shows a schematic flowchart of the method for examining test objects with x-ray radiation according to an exemplary embodiment of the disclosure.

### DESCRIPTION OF EXEMPLARY EMBODIMENTS

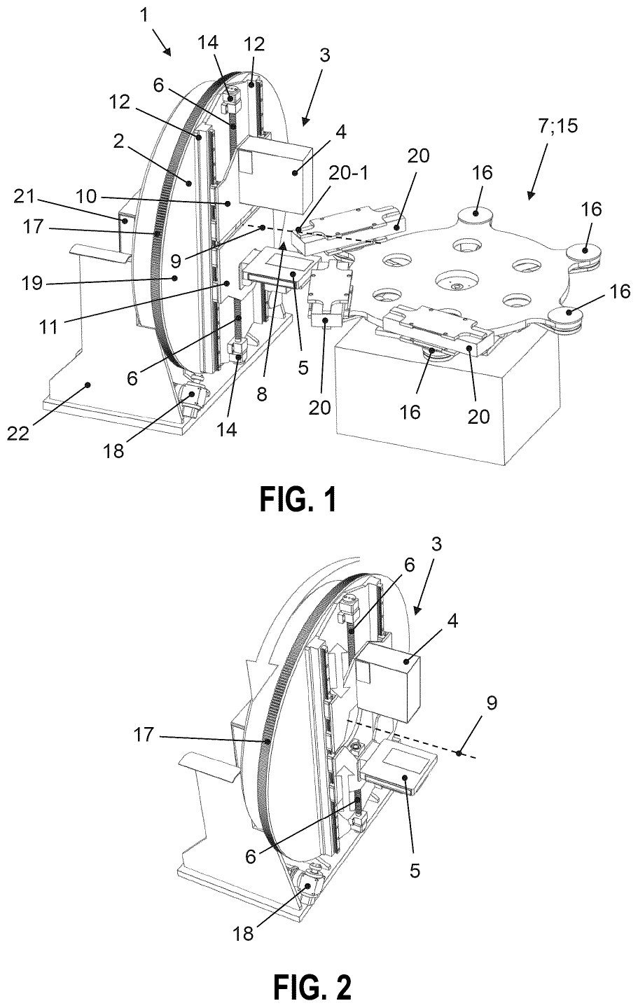

FIG. 1 shows a schematic illustration of an exemplary embodiment of the x-ray measurement arrangement 1 for examining test objects 20 with x-ray radiation. The x-ray measurement arrangement 1 includes a rotatable receptacle apparatus 2 and an x-ray examination apparatus 3 having at least one x-ray source 4 and at least one x-ray detector 5. The rotatable receptacle apparatus 2 is configured as a rotatable disk, in particular a circular rotatable disk.

The at least one x-ray source 4 and the at least one x-ray detector 5 are arranged on the rotatable receptacle apparatus 2, wherein the at least one x-ray source 4 and the at least one x-ray detector 5 are movable along a linear axis 6 that extends perpendicular to the axis of rotation 9 of the rotatable receptacle apparatus 2. In particular, the at least one x-ray source 4 and the at least one x-ray detector 5 are movable along a linear axis 6 that extends radially to the rotatable disk 2.

Furthermore, the x-ray measurement arrangement 1 includes at least one positioning apparatus 7, which is configured to arrange at least one predetermined region of interest 20-1 of a test object 20 in an acquisition region 8 of the x-ray examination apparatus 3 at an axis of rotation 9 of the rotatable receptacle apparatus 2, between the at least one x-ray source 4 and the at least one x-ray detector 5, and to keep said region of interest there during the examination.

In the exemplary embodiment shown in FIG. 1, the x-ray examination apparatus 3 includes an x-ray source 4 and an x-ray detector 5. The x-ray source 4 and the x-ray detector 5 are each arranged on carriages 10, 11, which are guided by way of two joint rails 12 on the rotatable receptacle apparatus 2. Each of the carriages 10, 11 is connected to a dedicated drive 14, with the drives 14 being configured as spindle drives. As a result, the two carriages 10, 11 with the x-ray source 3 and the x-ray detector 4 can be moved separately and independently of one another. The shown exemplary embodiment of the arrangement is chosen by way of example; in principle, the x-ray source 4 and the x-ray detector 5 may also be arranged on the rotatable receptacle apparatus 2 by other means.

In the exemplary embodiment shown in FIG. 1, the positioning apparatus 7 includes a positioning carousel 15 with six holders 16 for test objects 20. In particular, provision can be made for the holders 16 to be able to be rotated about an axis of rotation so as to be able to rotate a test object 20 that is arranged on the holders 16 and in this way bring the at least one region of interest 20-1 of a test object 20 into a position suitable for measurement.

In the exemplary embodiment shown in FIG. 1, provision is made for a gear ring 17 to be arranged on an external circumference of the rotatable receptacle apparatus 2 configured as a rotatable circular disk. A pinion (not shown) of a drive 18, for example of an electric motor, engages in this gear ring 17 and can rotate the rotatable receptacle apparatus 2 about the axis of rotation 9. As a result, the x-ray examination apparatus 3 may be rotated about a region of interest 20-1 of the test object 20 arranged on the axis of rotation 9 in the acquisition region, and so radiographs of the region of interest 20-1 can be acquired from different directions. A rotational movement of the rotatable receptacle apparatus 2 about the axis of rotation 9 is shown schematically in FIG. 2. FIG. 2 furthermore elucidates a movement of the x-ray source 4 and of the x-ray detector 5 along the linear axis 6 that extends perpendicular to the axis of rotation 9 of the rotatable receptacle apparatus 2 along the linear axis 6 extending radially.

The rotatable receptacle apparatus 2 configured as a rotatable disk in particular includes a circular base plate 19 in the exemplary embodiment shown in FIG. 2. The circular base plate 19 is mounted rotatably on a holding device 21, for example by way of a shaft and a pivot bearing. The holding device 21 is arranged on a base 22. During application, the axis of rotation 9 extends horizontally in particular, with a plane of the rotatable disk extending vertically. This enables a supply and removal of test objects 20 to and from the acquisition region 8 in the horizontal direction.

In the x-ray measurement arrangement 1, acquired radiographs are evaluated in a manner known per se. In particular, computed tomography measurements may be performed with the x-ray measurement arrangement 1. A control device configured to this end has not been shown for reasons of clarity but is configured in a manner known per se, in particular for control and evaluation purposes.

In the exemplary embodiment shown in FIG. 1, the test objects 20 are examined in such a way that regions of interest 20-1 of the test objects 20, in particular corners of batteries or battery cells, are in each case successively arranged on an individual basis in the acquisition region 8 on the axis of rotation 9, between the x-ray source 4 and the x-ray detector 5, by a rotation of the positioning carousel 15, and said regions of interest are kept there during a measurement. Within the scope of the measurement, radiographs are acquired over an angular range of at least 180° in particular, preferably over an angular range of at least 360°, by virtue of the rotatable receptacle apparatus 2 being rotated about the regions of interest 20-1. Provision can be made for a plurality of regions of interest 20-1 to be measured for each test object 20. To this end, the holders 16 of the positioning carousel 15 can each be rotated such that the test objects 20 can be rotated and a different region of interest 20-1 can be arranged in the acquisition region 8 on the axis of rotation 9, between the x-ray source 4 and the x-ray detector 5. In particular, drives (not shown) suitable for the respective application may be provided for the purpose of rotating the holders 16.

In particular, the x-ray measurement arrangement 1 may be used in a production line for quality control. Then, not yet examined test objects 20 can be supplied to the positioning carousel 16 from the side facing away from the rotatable receptacle apparatus 2, and already examined test objects 20 can be removed.

Provision can be made for the rotatable receptacle apparatus 2 to be configured such that the latter has no restrictions whatsoever on an angle of rotation about the axis of rotation 9. Then, electrical connections and/or wired signal lines are realized by way of sliding contacts in particular.

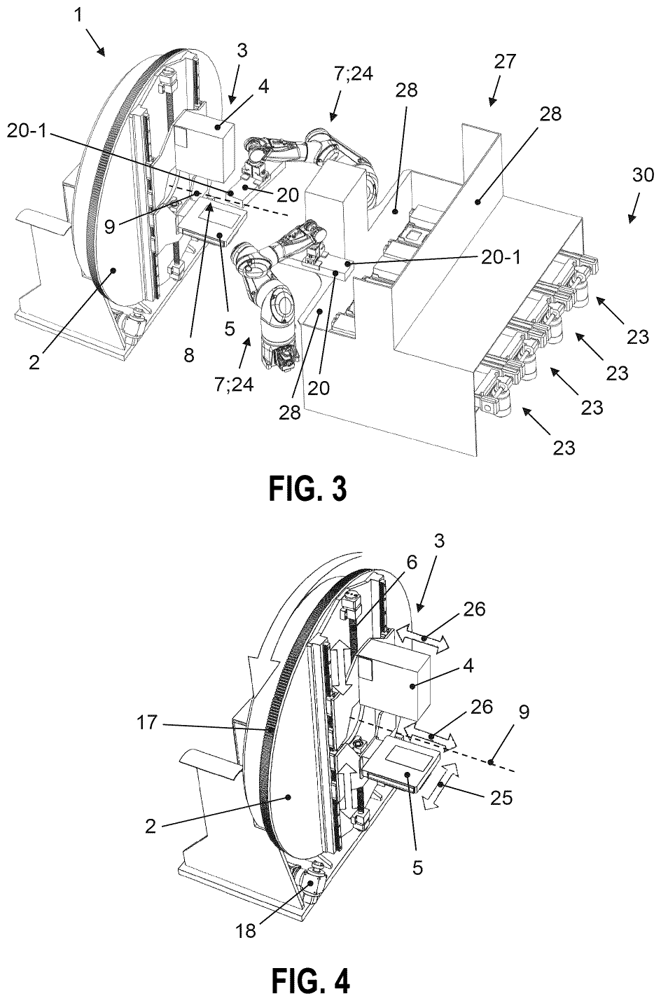

FIG. 3 shows a further exemplary embodiment of the x-ray measurement arrangement 1.

In principle, the exemplary embodiment is configured like the exemplary embodiment shown in FIG. 1. The same reference signs in FIG. 3 denote the same features and terms as in the preceding FIGS. 1 and 2. This exemplary embodiment provides for the x-ray measurement arrangement 1 to include at least two positioning apparatuses 7 that operate independently of one another and, in each case assigned to each of the at least two positioning apparatuses 7, supply and removal devices 23 for supplying and removing test objects 20 to be examined. The supply and removal devices 23 include a total of four conveyor belts. The positioning apparatuses 7 each include a robot arm 24, in particular a multi-joint robot arm 24. The robot arms 24 are configured to grip test objects 20 supplied with the supply and removal devices 23, in particular batteries or battery cells, and arrange a predetermined region of interest 20-1 of the gripped test object 20 in the acquisition region 8 on the axis of rotation 9, between the x-ray source 4 and the x-ray detector 5. After the examination, i.e., after the radiographs for reconstructing a tomographic object volume were acquired, the robot arm 24 transfers the examined test object 20 back to the supply and removal devices 23. In this case, the robot arms 24 operate alternately, and so the x-ray examination apparatus 3 capacity can be utilized optimally in time. In this case, provision can be made for a rotation of the rotatable receptacle apparatus 2 to be continual, even if no radiographs are currently being acquired. This can prevent repeated acceleration and deceleration of the rotatable receptacle apparatus 2 and thus prevent increased wear-and-tear of the bearing and the drive, etc.

FIG. 4 shows a part of a further exemplary embodiment of the x-ray measurement arrangement 1. In principle, the exemplary embodiment is configured like the exemplary embodiments described previously. In this case, the same reference signs in FIG. 4 denote the same features and terms as in the preceding FIGS. 1 to 3. This exemplary embodiment provides for the x-ray examination apparatus 1 to include a second linear axis 25 which is arranged perpendicular to the direction of the axis of rotation 9 and perpendicular to the direction of the linear axis 6 and along which the at least one x-ray detector 5 of the x-ray examination apparatus 3 can be displaced. For example, a movement along the second linear axis 25 can be implemented with a suitable drive (not shown), for example with a linear motor or a spindle drive.

FIG. 4 also elucidates a further exemplary embodiment. In this exemplary embodiment, provision is made for the x-ray measurement arrangement 1 to include at least one third linear axis 26 which extends parallel to the axis of rotation 9 and along which the x-ray source 4 and/or the x-ray detector 5 can be displaced. For example, a movement along the third linear axis 26 can be implemented with a suitable drive (not shown), for example with a linear motor or a spindle drive.

Provision can be made for a drive for moving the at least one x-ray source 4 and the at least one x-ray detector 5 along the linear axis 6 that extends perpendicular to the axis of rotation 9 of the rotatable receptacle apparatus 2 (and in particular extends radially) to be arranged outside of the rotatable receptacle apparatus 2. Then, coupling means (not shown) are provided, with which a mechanical connection to the drive can be established should a movement along the axis become necessary.

Provision can be made for the x-ray measurement arrangement 1 to include at least one wireless communications interface (not shown) that is arranged on the rotatable receptacle apparatus 2 and configured to provide radiographs acquired with the at least one x-ray detector 5. Sliding contacts for signal lines are not required in that case.

Provision can be made for the at least one x-ray source 4 to be a microfocus x-ray source.

Provision can be made for the at least one x-ray source 4 to include a monoblock x-ray tube.

Provision can be made for the at least one x-ray detector 5 to be embodied as a direct conversion x-ray detector. For example, the at least one x-ray detector 5 may include CdTe as active material.

Provision can be made for the at least one x-ray source 4 and/or the at least one x-ray detector 5 to have fluid cooling (not shown). In that case, elements of the fluid cooling are arranged on the rotatable receptacle device 2 in particular and are moved along during the rotation.

Provision can be made for the x-ray measurement arrangement 1 to include at least one door-free radiation lock 27. This is elucidated schematically on the basis of the exemplary embodiment shown in FIG. 3. In particular, the door-free radiation lock 27 includes a plurality of screens 28 (opaque to the x-ray radiation used) that are arranged such that there is no direct line of sight from an external area 30 to the at least one x-ray source 4, and so a primary radiation of the at least one x-ray source 4 cannot escape to the outside, and a secondary or scattered radiation is no longer detectable in the external area 30.

Provision can be made for the x-ray examination apparatus 3 to include a plurality of x-ray sources 4 and a plurality of x-ray detectors 5. The respective beam paths are then arranged offset by a difference angle about the axis of rotation 9 and so radiographs of the test object 20 can be acquired simultaneously from a plurality of different directions.

Provision can be made for the x-ray measurement arrangement 1 to include at least one collimator (not shown) and/or at least one stop element (not shown) and/or at least one filter element (not shown) which is/are configured to limit an x-ray radiation emanating from the at least one x-ray source 4 to an active detector surface of the at least one x-ray detector 5.

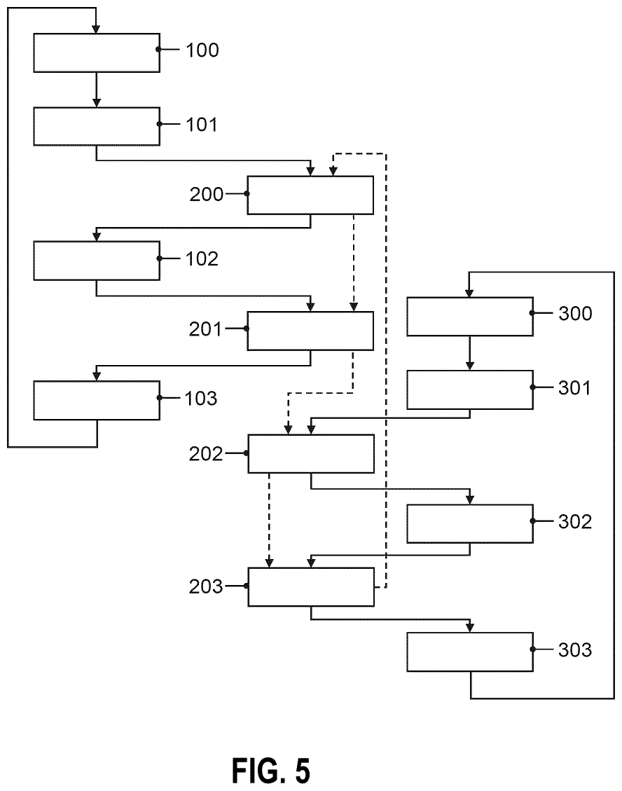

FIG. 5 shows a schematic flowchart of an exemplary embodiment of the method for examining test objects with x-ray radiation. In this exemplary embodiment, the method is performed by way of example with an x-ray measurement arrangement according to the exemplary embodiment shown in FIG. 3, i.e., positioning apparatuses including two robot arms are used. Method steps 100-103 are carried out by the first positioning apparatus, method steps 200-203 are carried out by the x-ray examination apparatus and the rotatable receptacle apparatus and method steps 300-303 are carried out by the second positioning device, wherein the procedures are synchronized to one another, as emerges from the flowchart and the following description. The test objects are examined and/or measured within the scope of the method, in particular by computed tomography, and are irradiated from different directions to this end.

In a method step 100, the first robot arm grips a test object, in particular a battery or battery cell, from one of the supply or removal devices.

In a method step 101, a predetermined region of interest of the gripped test object, in particular a corner of the battery or battery cell, is arranged in the acquisition region of the x-ray examination apparatus on the axis of rotation, between the x-ray source and the x-ray detector. In this case, provision can be made for a predetermined last segment of an arrangement trajectory to extend along the axis of rotation of the rotatable receptacle apparatus when arranging the at least one predetermined region of interest of the test object in the acquisition region, in order to avoid a collision with the x-ray source and the x-ray detector. In parallel with this, a rotation of the rotatable receptacle apparatus is started, or the rotatable receptacle apparatus is rotated continually, i.e., without a break.

In a method step 200, the region of interest of the test object is measured, with the measurement being started when a predetermined angular speed of the rotatable receptacle apparatus has been reached.

In a method step 102, the test object is repositioned by the first robot arm such that a further predetermined region of interest of the test object, in particular an opposite corner of the battery or battery cell, is arranged in the acquisition region on the axis of rotation, between the x-ray source and the x-ray detector. In particular, to this end the test object is removed from the acquisition region along the axis of rotation, repositioned and subsequently introduced along the axis of rotation back into the acquisition region with the further predetermined region of interest. In parallel with this, the rotatable receptacle apparatus can be accelerated again, or a rotational movement is maintained.

The further predetermined region of interest is measured in analogous fashion in a method step 201.

In a method step 103, the test object is removed from the acquisition region again, in particular along the axis of rotation, and transferred to the supply and removal device.

In parallel with this, the second robot arm grips a further test object, in particular a further battery or battery cell, from one of the supply or removal devices in a method step 300 and without impeding the first robot arm in the process moves the gripped further test object already into the vicinity of the acquisition region, where it waits.

Once the acquisition region has been vacated following method step 103, a predetermined region of interest of the gripped further test object, in particular a corner of the further battery or battery cell, is arranged in the acquisition region on the axis of rotation, between the x-ray source and the x-ray detector, in a method step 301. In this case, provision can also be made for a predetermined last segment of an arrangement trajectory to extend along the axis of rotation of the rotatable receptacle apparatus when arranging the at least one predetermined region of interest of the further test object in the acquisition region, in order to avoid a collision with the x-ray source and the x-ray detector. In parallel with this, a rotation of the rotatable receptacle apparatus is started, or the rotatable receptacle apparatus is rotated continually, i.e., without a break.

In a method step 202, the predetermined region of interest of the further test object is measured, with the measurement being started when a predetermined angular speed of the rotatable receptacle apparatus has been reached.

In a method step 302, the further test object is repositioned by the second robot arm such that a further predetermined region of interest of the further test object, in particular an opposite corner of the further battery or battery cell, is arranged in the acquisition region on the axis of rotation, between the x-ray source and the x-ray detector. In particular, to this end the further test object is removed from the acquisition region along the axis of rotation, repositioned and subsequently introduced along the axis of rotation back into the acquisition region with the further predetermined region of interest. In parallel with this, the rotatable receptacle apparatus can be accelerated again, or a rotational movement is maintained.

The further predetermined region of interest is measured in analogous fashion in a method step 203.

In a method step 303, the further test object is removed from the acquisition region again, in particular along the axis of rotation, and transferred to the supply and removal device.

Subsequently, the method is repeated for further test objects, with the positioning apparatuses always alternating for the arrangement and holding of the test objects.

In principle, further positioning apparatuses may be provided, with the procedure in principle being analogous.

An exemplary embodiment provides for method steps 200 to 203 to be run through in a different sequence: Especially if, e.g., the movement (method steps 102 and 302) for changing the region of interest takes longer than the interchange of the test objects by the two positioning apparatuses, provision can be made for method step 202 to be performed first after method step 200 and for the repositioning (method step 102) to be undertaken in parallel with this, followed by method step 201 and, in parallel with this, method steps 302 and 103. For two test objects with two regions of interest each, an examination is then implemented in the following sequence in particular: examining a first region of interest of the first test object, examining a first region of interest of the second test object, examining a second region of interest of the first test object and examining a second region of interest of the second test object. In the event of further test objects and further regions of interest, the method is carried out analogously.

### LIST OF REFERENCE NUMERALS

1 X-ray measurement arrangement
2 Rotatable receptacle apparatus
3 X-ray examination apparatus
4 X-ray source
5 X-ray detector
6 (First) linear axis
7 Positioning apparatus
8 Acquisition region
9 Axis of rotation
10 Carriage
11 Carriage
12 Rail
14 Drive
15 Positioning carousel
16 Holder
17 Gear ring
18 Drive
19 (Circular) base plate
20 Test object
20-1 Region of interest
21 Holding device
22 Base
23 Supply and removal device
24 Robot arm
25 Second linear axis (perpendicular to the direction of the axis of rotation)
26 Third linear axis (parallel to the axis of rotation)
27 Door-free radiation lock
28 Screen
30 External area
100 to 103 Method steps (first positioning apparatus)
200 to 203 Method steps (x-ray examination apparatus)
300 to 303 Method steps (second positioning apparatus)

1. An x-ray measurement arrangement (1) for examining test objects (20) by means of x-ray radiation, comprising:
a rotatable receptacle apparatus (2),
an x-ray examination apparatus (3) having at least one x-ray source (4) and at least one x-ray detector (5),
the at least one x-ray source (4) and the at least one x-ray detector (5) being arranged on the rotatable receptacle apparatus (2), and at least one positioning apparatus (7) that is configured to arrange at least one predetermined region of interest (20-1) of a test object (20) in an acquisition region (8) of the x-ray examination apparatus (3) at an axis of rotation (9) of the rotatable receptacle apparatus (2), between the at least one x-ray source (4) and the at least one x-ray detector (5), and to keep said region of interest there during the examination,
characterized by at least two positioning apparatuses (7) that operate independently of one another and, in each case assigned to each of the at least two positioning apparatuses (7), supply and removal devices (23) for supplying and removing test objects to be examined.

2. The x-ray measurement arrangement as claimed in claim 1, characterized in that the at least one x-ray source (4) and/or the at least one x-ray detector (5) are movable along a linear axis (6) that extends perpendicular to the axis of rotation (9) of the rotatable receptacle apparatus (2).

3. The x-ray measurement arrangement (1) as claimed in claim 1 or 2, characterized in that the rotatable receptacle apparatus (2) is arranged such that the axis of rotation (9) of the rotatable receptacle apparatus (2) extends horizontally.

4. The x-ray measurement arrangement (1) as claimed in any of the preceding claims, characterized in that the rotatable receptacle apparatus (2) is designed such that the latter has no restrictions whatsoever on an angle of rotation about the axis of rotation (9).

5. The x-ray measurement arrangement (1) as claimed in any of the preceding claims, characterized in that the at least one positioning apparatus (7) comprises a robot arm (24).

6. The x-ray measurement arrangement (1) as claimed in any of the preceding claims, characterized in that the at least one positioning apparatus (7) comprises a positioning carousel (15).

7. The x-ray measurement arrangement (1) as claimed in any of the preceding claims, characterized by a second linear axis (25) which is arranged perpendicular to a direction of the axis of rotation (9) and perpendicular to the direction of the linear axis (6) and along which the at least one x-ray detector (4) of the x-ray examination apparatus (3) can be displaced.

8. The x-ray measurement arrangement (1) as claimed in any of the preceding claims, characterized by at least one third linear axis (26) which extends parallel to the axis of rotation (9) and along which the at least one x-ray source (4) and/or the at least one x-ray detector (5) can be displaced.

9. The x-ray measurement arrangement (1) as claimed in any of claims 2 to 8, characterized in that a drive (14) for moving the at least one x-ray source (4) and/or the at least one x-ray detector (5) along the linear axis (6) that extends perpendicular to the axis of rotation (9) of the rotatable receptacle apparatus (2) is arranged outside of the rotatable receptacle apparatus (2).

10. The x-ray measurement arrangement (1) as claimed in any of the preceding claims, characterized by at least one wireless communications interface that is arranged on the rotatable receptacle apparatus (2) and configured to provide radiographs acquired by means of the at least one x-ray detector (5).

11. The x-ray measurement arrangement (1) as claimed in any of the preceding claims, characterized by at least one door-free radiation lock (27).

12. The x-ray measurement arrangement (1) as claimed in any of the preceding claims, characterized in that the x-ray examination apparatus (3) comprises a plurality of x-ray sources (4) and a plurality of x-ray detectors (5).

13. The x-ray measurement arrangement (1) as claimed in any of the preceding claims, characterized by at least one collimator and/or at least one stop element and/or at least one filter element which is/are configured to limit an x-ray radiation emanating from the at least one x-ray source (4) to an active detector surface of the at least one x-ray detector (5).

14. A method for examining test objects (20) by means of x-ray radiation,
wherein use is made of an x-ray measurement arrangement (1) as claimed in any of claims 1 to 13,
wherein the at least one positioning apparatus (7) is used to arrange at least one predetermined region of interest (20-1) of a test object (20) in the acquisition region (8) of the x-ray examination apparatus (3) on the axis of rotation (9) of the rotatable receptacle apparatus (2), between the at least one x-ray source (4) and the at least one x-ray detector (5), and to keep said region of interest there during the acquisition of at least one radiograph by means of the at least one positioning apparatus (7),
characterized in that at least two positioning apparatuses (7) that operate independently of one another are used with supply and removal devices (23), in each case assigned to each of the at least two positioning apparatuses (7), for supplying and removing test objects (20) to be examined, in order to arrange the at least one predetermined region of interest (20-1) of the test objects (20) in the acquisition region (8).

15. The method as claimed in claim 14, characterized in that the at least two positioning apparatuses (7) are used alternately in the process.

16. The method as claimed in claim 14 or 15, characterized in that a predetermined last segment of an arrangement trajectory extends along the axis of rotation (9) of the rotatable receptacle apparatus (2) when arranging the at least one predetermined region of interest (20-1) of the test object (20) in the acquisition region (8).

17. The method as claimed in any of claims 14 to 16, characterized in that at least two positioning apparatuses (7) that operate independently of one another are used with supply and removal devices (23), in each case assigned to each of the at least two positioning apparatuses (7), for supplying and removing test objects (20) to be examined, in order to arrange the at least one predetermined region of interest (20-1) of the test objects (20) in the acquisition region (8), with the at least two positioning apparatuses (7) being used alternately in the process.
